(19) United States
(12) Patent Application Publication
(10) Pub. No.: US 2016/0359338 A1
(43) Pub. Date: Dec. 8, 2016

(54) Intelligent Charger

(71) Applicant: Yuan Gao, Shenzhen (CN)

(72) Inventor: Yuan Gao, Shenzhen (CN)

(73) Assignee: AAC Technologies Pte. Ltd., Singapore city (SG)

(21) Appl. No.: 15/006,451

(22) Filed: Jan. 26, 2016

(30) Foreign Application Priority Data
Jun. 4, 2015 (CN) 201520382692.0

(51) Int. Cl. H02J 7/00

(52) U.S. Cl. CPC H02J 7/0003; H02J 7/0047; H02J 7/0042; H02J 7/007; H02J 2007/0001; H02J 2007/0096

(57) ABSTRACT

An intelligent charger is disclosed. The intelligent charger includes a charger body; a charge port set in the charger body; a detection circuit used for detecting rated voltage and rated current of the device to be charged; and an MCU control circuit used for controlling the output voltage and rated current of the charge port and connected electrically with the charging circuit.

### FIELD OF THE INVENTION

The present disclosure relates to chargers, and more particularly to an intelligent charger.

### DESCRIPTION OF RELATED ART

At present, there are a variety of electronic products around us, MP3, PSP, e-book reader, PDA, electric shaver, digital camera, intelligent cell phone, tablet PC and wearable devices etc. Almost all these devices are equipped with independent charger. However, almost every family has at least one set of the above-mentioned electronic products. With the acceleration of replacement of these electronic products, each family can find various chargers easily applicable to these electronic products. For these chargers, we should throw away the chargers corresponding previous electronic products directly. As on one side, new electronic product will be equipped with new charger. On the other side, we are not willing to charger mixedly, as we worry about the problem of matchability.

It will bring the two-sided problem obviously as we equip new charger: One is that we have to pay for new charger and cable. The second one is that resource is wasted seriously, as those old chargers are good and can be used normally for a number of years. Although the interface of these electronic products maybe be the same, if we use old charger to charge new electronic products, it will exist the following obvious problems:

### 1) Inconsistent Charging Current

The same is 5.0V voltage. The charge current for iPad is 2.1 A. It is 1000 mA, 800 mA or 500 mA for many cell phones, around 300 mA for MP3. It may have other rated currents for other electronic products. Using these chargers mixedly will lead too slow charging, damage electronic products and break out fire etc problems due to large calorific value and not turn off circuit timely.

### 2) Inconsistent Charging Voltage

Inconsistent charging voltage may cause abnormal charging, damage electric appliance and break out fire.

Therefore, it is necessary to provide a new intelligent charger to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustration of an intelligent charger of an exemplary embodiment of the present disclosure.

FIG. 2 is an electrical schematic diagram of the intelligent charger.

FIG. 3 is a connection diagram of the intelligent charger and a control terminal.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

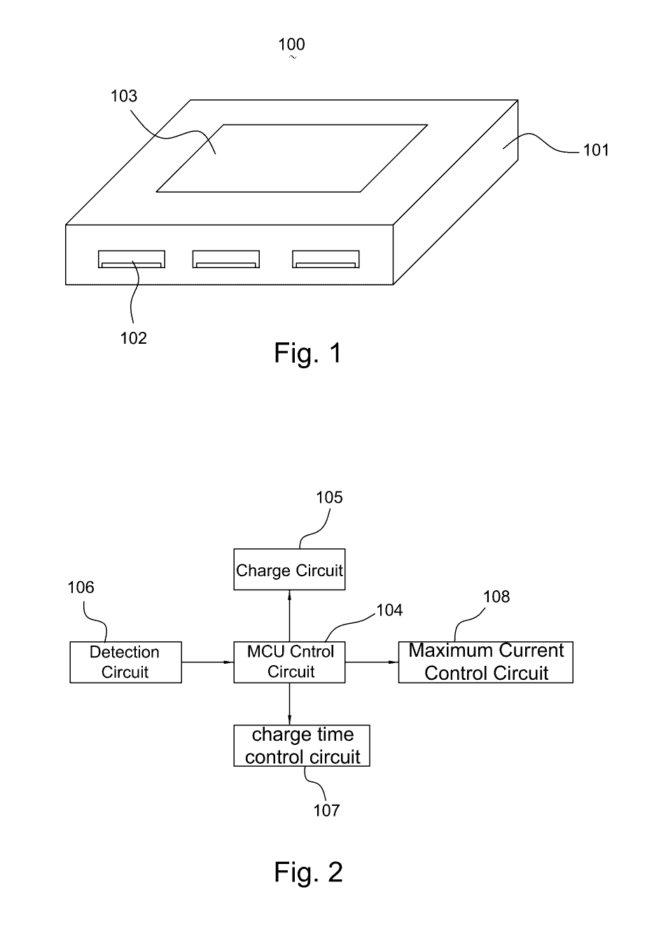

As shown in FIGS. 1-2, an intelligent charger 100 includes a charger body 101, a plurality of charge ports 102 and an LCD 103 used for displaying charging state. Output voltage and rated current are set on the charger body 101. A plug (not shown) is set in the charger body 101. The plug (not shown) is connected with external power source.

A detection circuit 106 used for detecting the output voltage and rated current of the devices to be charged. A MCU (Microcontroller Unit) control circuit 104 used for controlling the output voltage and rated current of charge port 102, a charge circuit 105 connected electrically with the MCU control circuit 104, a charge time control circuit 107 and a maximum current control circuit 108 are set inside the charger body 101. When the device to be charged is connected with the charger body 101 through data cable and charge port 102, the detection circuit 106 will detect the rated voltage and rated current of the devices to be charged automatically and feedback the data of rated voltage and rated current of the devices to be charged to the MCU control circuit 104. The MCU control circuit 104 controls the output voltage and rated current of charge port 102 connected with the devices to be charged. LCD 103 can display the charging state of the devices to be charged, such as it is charged or charging is finished and the output voltage and rated current of charge port too. Besides, the charge time and maximum current can be set through LCD 103 to prevent devices from being damaged due to overcharge to maximize protection and utilization of the battery of devices to be charged.

It is noteworthy that the quantity of charge ports 102 can be one or more and the output voltage and rated current of any one of charge port 102 can be controlled through the MCU control circuit 104.

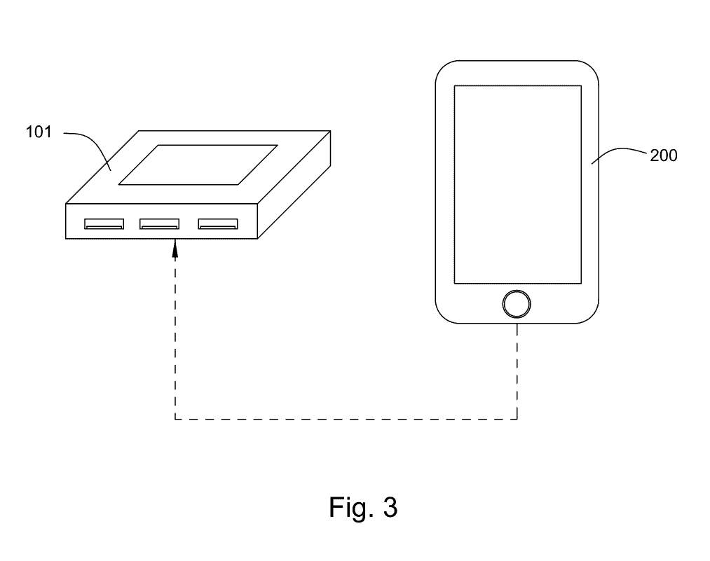

As shown in FIG. 3, the intelligent charger 100 can include a control terminal 200 connected wirelessly with the charger body 101. The control terminal 200 can be a cell phone, a tablet PC or other wearable devices. Software program matching the intelligent charger 100 can be installed inside the control terminal 200. Charger body 101 can be connected wirelessly with control terminal 200 through NFC, Bluetooth or WIFI modes and through cable. The output voltage and rated current of charge port 102 can be set remotely through control terminal.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An intelligent charger, comprising:
a charger body;
a charge port set in the charger body;
a detection circuit used for detecting rated voltage and rated current of the device to be charged;
an MCU control circuit used for controlling the output voltage and rated current of the charge port and connected electrically with the charging circuit.

2. The intelligent charger in claim 1 further comprising an LCD displaying charging state, output voltage and rated current.

3. The intelligent charger in claim 1 further including a charge time control circuit and a maximum current control circuit connected electrically with the MCU control circuit.

4. The intelligent charger in claim 1 comprising one or more charge ports.

5. The intelligent charger in claim 1, comprising a control terminal used for controlling remotely the output voltage and rated current of the charge port, the control terminal being connected with the charger body wirelessly.

6. The intelligent charger in claim 5, wherein the control terminal includes a cell phone, a tablet PC or a wearable device.

7. The intelligent charger in claim 5, wherein the charger body is connected with the control terminal through NFC, Bluetooth or WIFI.

8. The intelligent charger in claim 5, wherein the charger body is connected with the control terminal through cable.
